(19) United States
(12) Patent Application Publication
(10) Pub. No.: US 2021/0086800 A1
(43) Pub. Date: Mar. 25, 2021

(54) POWER SYSTEM AND METHOD FOR A LOCOMOTIVE

(71) Applicant: Progress Rail Locomotive Inc., LaGrange, IL (US)

(72) Inventors: Scott A. Swenson, Burr Ridge, IL (US); Alexander Shubs, Mt. Prospect, IL (US); Garrett Nielson, Schererville, IN (US); Eric Schamber, Riverside, IL (US)

(73) Assignee: Progress Rail Locomotive Inc., LaGrange, IL (US)

(21) Appl. No.: 17/028,100

(22) Filed: Sep. 22, 2020

Related U.S. Application Data
(60) Provisional application No. 62/903,910, filed on Sep. 22, 2019.

(51) Int. Cl. B61C 3/02; B61D 27/00; F02B 63/04; B60L 50/60; B60L 1/00; B60L 58/12; B60L 1/02; B60L 1/14; F02N 11/08; B60L 58/16; B60L 58/24; G01S 19/42

(52) U.S. Cl. CPC B61C 3/02; F02N 2200/061; F02B 63/042; B60L 50/60; B60L 1/006; B60L 58/12; B60L 1/02; B60L 1/14; F02N 11/0833; B60L 58/16; B60L 58/24; G01S 19/42; B60L 1/003; B60L 2240/622; F02N 2200/064; B61D 27/00

(57) ABSTRACT

A power system for a locomotive includes an engine, an alternator, an electrical system, a primary load, an auxiliary load, a battery and a battery management system. The alternator is coupled to the engine. The electrical system is electrically powered by the alternator. The primary load, auxiliary load, and battery are electrically connected to the electrical system. The primary load is configured to provide the primary motive power for the locomotive. The battery management system is electrically connected to the battery and configured to monitor the battery and provide power to the auxiliary load when the engine is off and at least one battery condition is met. The battery management system is in communication with a back office to provide information on the at least one battery condition.

### TECHNICAL FIELD

The present disclosure relates to a power system and method for a locomotive, and more particularly, to a system and method for a locomotive having a battery management system.

### BACKGROUND

To conserve fuel and reduce emissions, locomotives have been equipped with systems for automatically starting and stopping their engines when one or more conditions exist. These systems are referred to as automatic engine start stop (AESS) systems. While effective, locomotive operators will frequently take steps to prevent the AESS system from engaging to provide heating and air conditioning to the operator cabin or to maintain a certain pressure in the air brake system, for example, as current locomotive lead acid batteries have insufficient capacity to adequately power such loads. In addition, locomotives are frequently equipped with lower-power devices such as telematics that allow communication between the locomotive and a back office, lights, sensors and cameras. Railroads frequently desire to provide power to those lower-power devices even when the locomotive engine is not running.

U.S. Pat. No. 9,793,732 discloses a battery backed Power-over-Ethernet (PoE) system for delivering power to a load. PoE is a method of transmitting electrical power and data simultaneously over standard twisted-pair cables, such as standard Ethernet cables used in network infrastructures. The system disclosed in the '732 patent includes a powered device such as a network switch and an Ethernet power sourcing device configured to supply DC power to the powered device. The power sourcing device includes a battery, a battery charge unit, and a processor, the processor being arranged to monitor the current requirement of the load and to control the charging of the battery and the current from the battery to the load.

The '732 system preferentially uses a lead-acid battery as is commonly equipped on diesel-electric locomotives. As mentioned above, such locomotive power systems using lead-acid batteries lack sufficient capacity to power auxiliary loads using only the battery.

Thus, there is a desire to have a locomotive power system capable of providing power to auxiliary components while maintaining sufficient charge to restart the locomotive engine after the locomotive engine has been shut down.

The present disclosure is directed to overcoming one or more problems set forth above and/or problems of the prior art.

### SUMMARY OF THE DISCLOSURE

In one aspect of the present disclosure, a power system for a locomotive includes an engine, an alternator, an electrical system, a primary load, an auxiliary load, a battery and a battery management system. The alternator is coupled to the engine. The electrical system is electrically powered by the alternator. The primary load, auxiliary load, and battery are electrically connected to the electrical system. The primary load is configured to provide the primary motive power for the locomotive. The battery management is electrically connected to the battery and configured to monitor the battery and provide power to the auxiliary load when the engine is off and at least one battery condition is met.

In another aspect of the present disclosure, a method to supply power in a locomotive is provided. The locomotive has an engine, an alternator coupled to the engine, an electrical system that is electrically powered by the alternator, a primary load, an auxiliary load and a battery electrically connected to the electrical system. The method includes the steps of monitoring a condition of the battery, determining whether the condition of the battery is below a threshold value, causing power to be provided to the auxiliary load and not the primary load from the battery when the engine is off and the condition is not below the threshold value, and communicating with a back office to provide the condition of the battery.

Other features and aspects of this disclosure will be apparent from the following description and the accompanying drawings.

### BRIEF DESCRIPTION OF THE DRAWINGS

FIG. 1 illustrates a cut-away view of a locomotive and its associated power system and auxiliary components, in accordance with one embodiment of the present disclosure;

FIG. 2 illustrates a battery for the locomotive power system;

FIG. 3 illustrates one embodiment of the construction of the battery or second battery for the locomotive power system;

FIG. 4 graphically illustrates battery output voltage as a function of time for lead acid and lithium-ion batteries; and

FIG. 5 illustrates a method of providing power to a locomotive through a locomotive power system.

### DETAILED DESCRIPTION

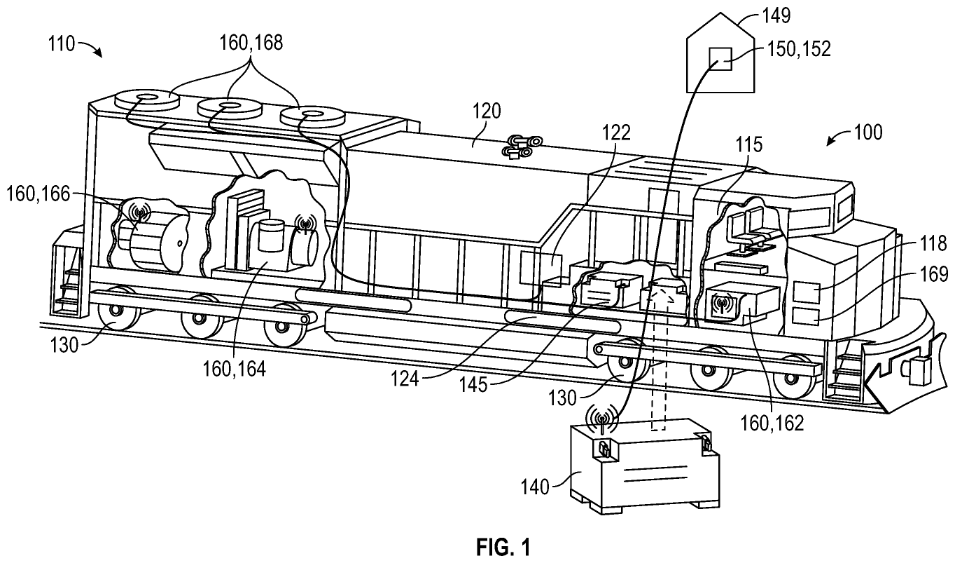

FIG. 1 illustrates a cut-away view of a locomotive 100, taken along the short hood end and accessory end of the locomotive 100. The locomotive 100 includes a power system 110 having an engine 120. The engine 120 may generate torque that is transmitted to an alternator 122. The alternator 122 then uses the torque to generate electricity for the power system 110 of the locomotive 100. The electrical system 124 is electrically powered by the alternator 122. The power system 110 provides electricity to a primary load 130, a battery or a first battery 140, at least one first auxiliary load 160, and at least one second auxiliary load 169, all of which are controlled by a locomotive control system 115.

The primary load 130 are the plurality of traction motors used to provide propulsion to the locomotive 100. The at least one first auxiliary load 160 may include a heating ventilation and air conditioning (HVAC) system 162, a motor driven air compressor (MDAC) 164, a blower 166, and a plurality of cooling fans 168. The at least one second auxiliary load 169 may include one or more of a network switch, a sensor, a camera, a plurality of lights and telematic devices for communication offboard the locomotive 100. The second auxiliary load 169 may be powered via a lower voltage PoE (not shown), in contrast to the higher voltages required for the primary load 130 or the first auxiliary load 160. The power system 110 may also include a second battery 145 for additional energy storage capacity.

The power system 110 may also include an AESS system 118 that is configured to shut down the engine 120 when certain conditions are met to conserve fuel and reduce overall engine emissions. AESS 118 may be engaged when the output voltage of the battery 140 is greater than 71 Volts, the ambient temperature is greater than 38 Degrees Fahrenheit, or the main compressed air reservoir (not shown) pressure exceeds 125 psi. The AESS system 118 is configured to restart the locomotive engine 120 when other conditions are met, such as a low state of charge (SOC) of the first battery 140 and/or the second battery 145, low ambient temperatures or a low temperature of the engine 120, or low pressure in the compressed air reservoir (not shown), such as at less than 105 psi.

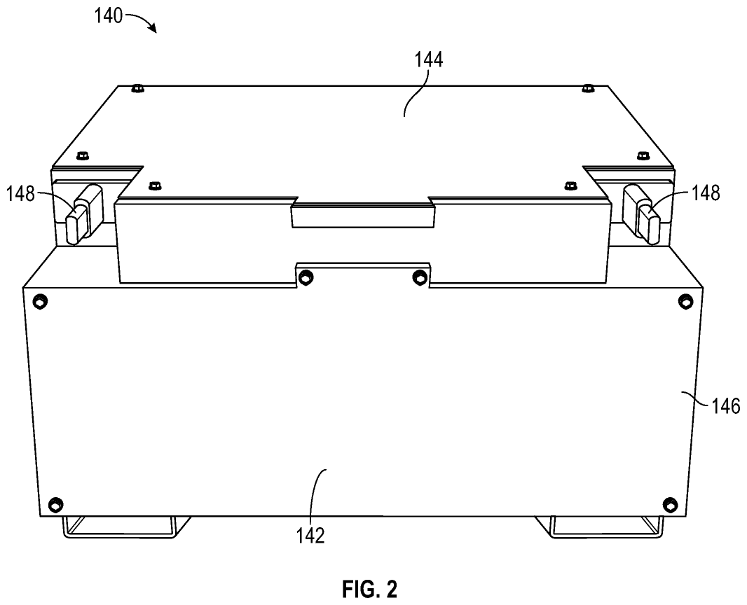

FIG. 2 illustrates the battery 140 for the locomotive power system 110. The battery 140 includes a battery enclosure 142 that houses a battery management (BMS) 144, a plurality of lithium-ion cells 146, and two output terminals 148. The BMS 144 monitors and controls the charging and discharging of battery 140. The PoE power feed from the battery 140 can act as a primary or secondary (redundant) power source for the second auxiliary loads 169, such as equipment connected to the network switch (not shown), which would improve the resilience and reliability of these applications. The BMS 144 will continuously monitor the power draw (Amps) and will provide energy for PoE until a limit is reached where the locomotive 100 needs to preserve enough battery 140 energy to allow for engine 120 restart. At this point in time, a message will be created and sent over the locomotive off-board gateway (not shown) or telematics device (not shown) if available, alerting the back office 150 to the fact that the battery 140 is being preserved for restart and at that time the energy for the PoE (not shown) will be cut-off. The BMS 144 will have the capability to detect a bad or failed module 146 or lithium-ion cell 146 in the battery 140. The BMS 144 will use a contactor (not shown) to isolate the failed or bad module 146 and continue to provide energy to the PoE without interruption.

The BMS 144 is in operative communication with the lithium-ion cells 146 of the battery 140 to monitor the state of charge and health of battery 140. Further, the BMS 144 may include a processor (not shown) to monitor the voltage, temperature and pressure of the battery 140. The BMS 144 can disconnect the power that the battery 140 supplies to the auxiliary loads 160 or second auxiliary loads 169 when, for example, the output voltage of battery 140 falls below a predetermined threshold voltage. The predetermined threshold voltage may be based on the minimum battery 140 output potential sufficient to restart the locomotive engine 120 or may be calculated by the BMS 144 in real-time. The BMS 144 may include a series of contactors (not shown) that allow for the reconfiguration of battery cells 146 to provide output voltages ranging from 64V to 450 V. Further, the battery cells 146 can be configured in a series or parallel arrangement. The BMS 144 may also include a modem (not shown) to allow data to be collected from the locomotive 100 and transferred to an offboard facility 149 when the engine 120 is off.

In one embodiment, the BMS 144 is located on the locomotive 100 and may be in communication with the back office 150 to provide information about the condition of the battery or batteries 140 on the locomotive 100. For example, the BMS 144 may be in communication with an off-board remote control interface or server 152. This remote control interface 152 could be housed in an offboard facility 149. The remote control interface 152 may be configured to receive data from the BMS 144, such that the information may be forwarded to railroad personnel via a mobile handheld device such as a cell phone, email or other display about the condition of the battery 140. The remote control interface 152 may be equipped with an antenna 155 configured to wirelessly transmit or receive messages from the BMS 144. Additionally, messages may also be sent from a back office 150 in the rail yard or to a third-party server such as (“the cloud’) by wire and/or wireless connections. Similarly, the remote control interface 152 may also be a satellite (not shown) that transmits and or receives information from the BMS 144 on the locomotive 100 to the remote control interface 152. Additionally, the information communicated to the remote control interface 152 from the locomotive 100 may also provide information to be used for remote monitoring, diagnostics, asset management, and tracking the state of charge and state of health of the primary power systems 130 and auxiliary systems 162 such as HVAC, lights, etc. Additionally, this has the benefit of improving reliability of the locomotive 100, as the operator may have information about the condition of the battery 140, such as current and voltage without having to physically touch or tear down the battery 140 from the locomotive 100 in order to ascertain the condition of the battery 140.

In another embodiment, the BMS 144 may be physically located in the back office 150. For example, as long as the BMS 144 is in constant communication with the battery 140, this has the benefit of freeing up valuable space on the locomotive 100 that could be used for other equipment on the locomotive 100. Additionally, the BMS 144 may be used as an additional computing device for the locomotive 100 for monitoring other equipment on the locomotive 100 besides the battery 140.

The battery 140 may be equipped with a radio antenna 155 for communication offboard the locomotive 100. For example, the BMS 144 may be equipped with a 4G LTE antenna 155 or otherwise connected with the communication system (not shown) of the locomotive control system 115. Such an antenna 155 would allow the locomotive 100 to communicate offboard the locomotive 100 when the engine 120 is off. In addition, if a technician is using augmented reality to service the locomotive 100, the PoE provided to the second auxiliary load 169 may store the configuration of the locomotive 100, including the road number and the configuration of various major components and communicate that information and data to the technician or service tool.

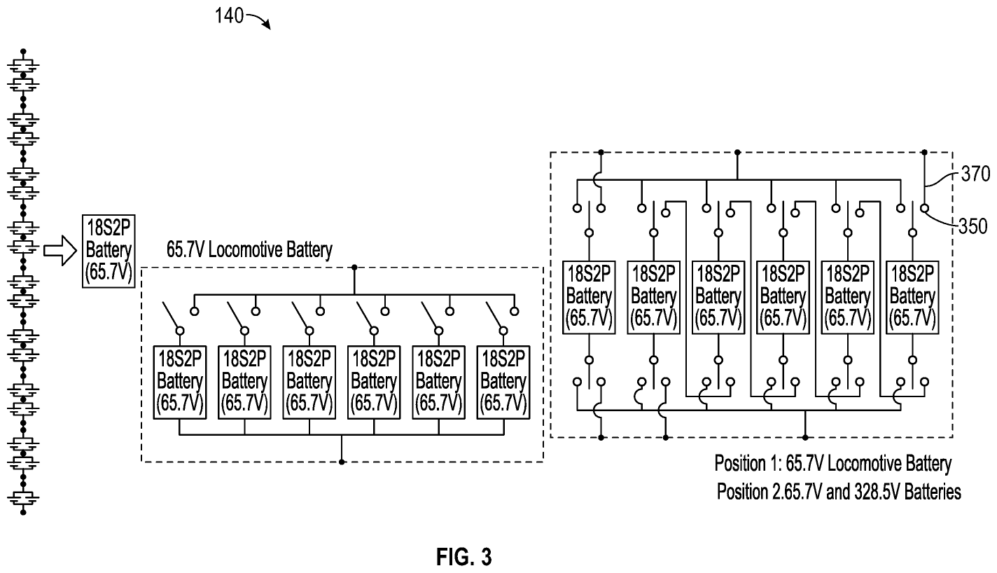

FIG. 3 illustrates one possible embodiment for the battery 140 or second battery 145. The battery 140 or secondary battery 145 may be constructed from a plurality of lithium-ion cells 146 to replace the widely used lead-acid batteries 340 used for locomotives 100. In order to meet the energy and power demands of the locomotive 100, the battery 140 or second battery 145 would be comprised of several smaller lithium cells 146 connected in series and parallel to achieve an equivalent battery 140 voltage and energy as the standard lead acid battery 340. Lithium-ion batteries 270 for starting locomotives 100 have the capacity to provide voltage and energy to power auxiliary equipment for days and preserve enough energy to restart the locomotive 100.

This system construction differs from lead acid batteries 340 in which the energy is increased by simply building a bigger cell 146 with more lead plate surface area and material to meet the energy and power requirements. Locomotive lead acid batteries 340 are typically comprised of 32 cells connected in series for a standard 64V system of varying amounts of energy dependent on the lead acid cell (not shown) construction. A proposed lithium-ion battery 270 to replace the lead acid battery 340 on a locomotive 100 would be built from 216 individual lithium-ion cells 146 connected in configuration of 18 series connections and 12 parallel connections (18S12P) for a nominal voltage of 65.7 and energy of 675 ampere-hours. The proposed system would connect the parallel strings on batteries 140 using contactors 350 and fusing 370. Typically, this connection is done through a single-pole-single-throw contactor 350 but if single-pole-two-throw contactors 350 are used the parallel connections could be reconfigured to series connections. This would allow the battery 140 to be configured into two batteries 140 on the locomotive 100. One battery 140 would be 18S2P resulting in 65.7 volts for the locomotive 100, while the other battery 145 would be a 90S2P system resulting in 328.5 volts. The increased voltage would allow for the locomotive auxiliary systems 160 such as the air compressor 166 to be powered from the battery 145 and therefore eliminate the immediate need to restart the engine 120 to run these auxiliary loads 160. Due to the energy and power density of lithium when compared to lead acid, the proposed system 110 would still be contained within the standard lead acid battery box 142 on the locomotive 100. This idea could be applied to several types of configurations of different voltages and this example is given as only one of these possibilities.

Once the battery 140 has been depleted or the engine 120 must be restarted, the battery 140 would then be reconfigured to the standard 18S12P configuration in order to charge the entire battery 140 from the standard locomotive battery charger (not shown). The BMS 144 would provide cell balancing to ensure that all battery cells 146 are charged fully to prepare for the next shutdown cycle. While the first battery 140 and second battery 145 are described as lithium-ion batteries 270, other rechargeable batteries 140 with similar characteristics may also be used.

The first battery 140 and second battery 145 would be designed to meet industry standards such as: the United Nations/Department of Transportation's (UN/DOT 38.3) Requirements for “Testing for Lithium Cells”; the Japanese Industrial Standard's (JIS c 8715-2) for “Secondary Lithium Cells and Batteries for Use in Industrial Applications-Part 2: Tests and Requirements of Safety” or the International Electrotechnical Commission's (IEC62619) Requirements for “Secondary Cells and Batteries Containing Alkaline or Other Non-Acid Electrolytes-Safety Requirements for Secondary Lithium Cells and Batteries, for Use in Industrial Applications”.

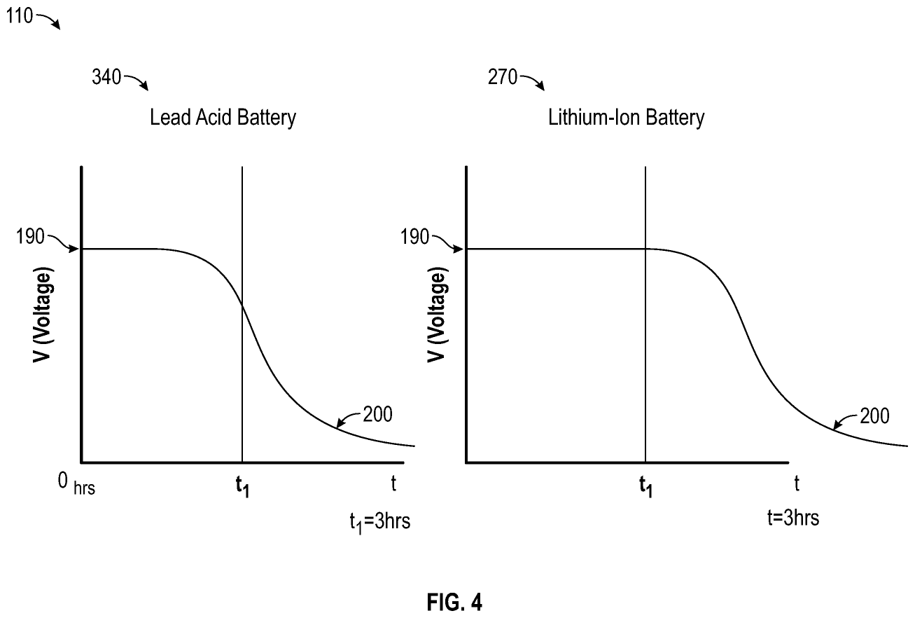

FIG. 4 illustrates battery 140 output voltage as a function of time for a typical locomotive lead acid battery 340 and a lithium-ion battery 270. For example, when charged to the same initial starting voltage and providing the same output voltage, the typical locomotive lead-acid battery 340 will have a lower voltage at time t1 than the lithium-ion battery 270 at the same time t1 for the same energy draw. As illustrated, the lithium-ion battery 270 maintains a steadier state of charge or voltage for a longer time, across the same threshold or predetermined time frame, before the lithium-ion battery 270 is totally discharged. Thus, the lithium-ion battery 270 is better able to provide power for a longer period of time on the locomotive 100 before the lithium-ion battery 270 is discharged when the AESS 118 has turned the engine 120 off.

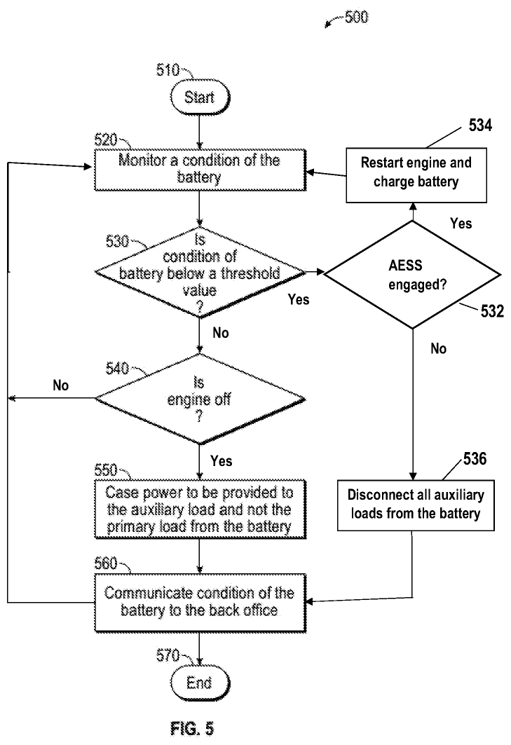

FIG. 5 illustrates a method 500 of providing power to a locomotive 100. At step 510, the engine 120 is off. The engine 120 may be off due to the AESS 118, because the locomotive 100 is parked without any intent to operate it in the future, because the locomotive 100 is being serviced, etc. At step 520, the BMS 144 monitors a condition of the battery 140 such as the battery's 140 state of charge or health. At step 530, the BMS 144 determines whether the state of charge or the state of health of the battery 140 is below a certain threshold. If the state of charge or the state of health of the battery 140 is below the threshold, the method 500 proceeds to Step 532, where the BMS 144 determines whether the AESS 118 is engaged. If the AESS 118 is not engaged, the method 500 proceeds to step 536 where all auxiliary loads 160 or 169 are disconnected from the battery 140 and the method 500 proceeds to step 560. If the AESS 118 is engaged, the BMS 144 restarts the engine 120 to recharge the battery 140 and the method 500 goes back to step 520. At step 530, if the state of charge or the state of health of the battery 140 is not below the threshold, the method 500 proceeds to step 540, where the BMS 144 confirms that the engine 120 is still off and the method 500 proceeds to Step 550. At step 550, the BMS 144 provides power from the battery 140 to the first auxiliary load 160 and/or to the second auxiliary load 169 via the PoE. At Step 560, the condition of the battery 140 is communicated to the back office 150. If the engine 120 is not off or if the AESS 118 is engaged, the method 500 would continue and return to step 520 described above.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functionalities of components, such features may be omitted from the scope of the present disclosure without departing from the spirit of the present disclosure as defined in the appended claims.

### INDUSTRIAL APPLICABILITY

In operation, the disclosed locomotive power system 110 allows the use of the battery 140 to both start the locomotive 100 as well as to provide a power source for small auxiliary loads 169 through PoE for second auxiliary loads 169, including the telematics devices, sensors, and cameras, or to or to higher power first auxiliary loads 160, especially if second battery 145 is added. The locomotive power system 110 includes the ability to disconnect any auxiliary loads 160, 169 to preserve locomotive 100 starting capability. This architecture also enables the locomotive 100 to off-board battery 140 health and operational information in running or shutdown states and alert the locomotive 100 maintainer, owner, or operator to battery 140 problems before they cause delays to the railroad.

When the engine 120 is not running and the locomotive 100 is in a shutdown state, the battery 140 may provide power to second auxiliary loads 169 through PoE to provide energy from the battery 140 to power a network switch and power all auxiliary equipment 169 connected to the network switch, such as telematics devices, sensors, and cameras. Theoretically, if the locomotive 100 is shutdown, telematics is lost, locomotive 100 position reporting, battery 140 health, camera feeds, and other data transfers from the locomotive 100 cannot occur until the locomotive 100 is running again. The locomotive power system 110 allows a permanent access to the battery 140 to utilize PoE to provide energy (voltage) from the battery 140 to power a network switch and any device plugged into the network switch preserving some critical data transfer capabilities from the locomotive 100 during periods of engine 120 shutdown. The PoE power feed from the battery 140 can act as a primary or secondary (redundant) power source for the auxiliary equipment connected to the network switch, improving resilience and reliability of these applications.

The proposed lithium-ion construction of battery 140 may be used as a starting battery 140 for the locomotive 100 which offers many advantages, including eliminating dead battery 140 issues, reducing locomotive 100 starts and delivering reliable starting from −25 C to 40 C, reducing locomotive 100 fuel consumption, reducing battery 140 charge time and delivering longer battery 140 life (i.e., up to 10 years of battery 140 life). Additionally, the battery 140 uses the BMS 144 to enable precise determination of battery 140 health, state of charge and battery 140 management directly to a locomotive 100 platform.

A single lithium-ion battery pack 270 can replace a 64 Volt lead-acid battery system comprised of two traditional 32 Volt lead-acid battery packs on the locomotive 100. This enables the second available battery box 142 on the locomotive 100 to be used by a second battery 145 and enable the HVAC system 162, for example, to be operated up to six hours while the locomotive engine 120 is shutdown. In addition, both battery 140 and second battery 145 are designed to be drop-in replacements for the typical, traditional lead-acid batteries 340 currently used on locomotives 100. Other motor driven accessories such as MDACs 164, blowers 166 or cooling fans 168 could also be run of the second battery 145.

Also, in locomotive 100 applications, the lithium-ion battery 270 can achieve two to three times greater startability (down to −25 C) as compared to a healthy lead-acid battery 340 and will generally reliably start a locomotive 100 with a lower state of health. Moreover, the lithium-ion battery 270 charges up to four times faster, enabling the locomotive 100 to remain shut down longer when the AESS 118 has turned off the engine 120, has no maintenance and reduced dead battery 140, 270 issues and is three to four times lighter than the traditionally used lead-acid batteries 340. Further, the lithium-ion battery 270 offers 15 kWh, 30 kWh and 45 kWh variations depending upon the application and configuration of the lithium-ion cells 146.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

1. A power system for a locomotive comprising:
an engine;
an alternator coupled to the engine;
an electrical system that is electrically powered by the alternator;
a primary load electrically connected to the electrical system and configured to provide the primary motive power for the locomotive;
an auxiliary load electrically connected to the electrical system;
a battery electrically connected to the electrical system; and
a battery management system electrically connected to the battery and configured to monitor the battery and provide power to the auxiliary load when the engine is off and an at least one battery condition is met; wherein the battery management system is in communication with a back office to provide information on the at least one battery condition.

2. The power system for a locomotive of claim 1 wherein the auxiliary load is electrically connected to the electrical system via Power over Ethernet.

3. The power system for a locomotive of claim 2, wherein the auxiliary load is one of a network switch, a sensor, a camera, a plurality of lights or a telematic device.

4. The power system for a locomotive of claim 2, wherein the auxiliary load is a first auxiliary load and the locomotive further comprises:
a second auxiliary load electrically connected to the electrical system, wherein the second auxiliary load is one of a heater, an air conditioner, a blower, a cooling fan or a motor driven compressor.

5. The power system for a locomotive of claim 2 further comprising an automatic engine start stop (AESS) system connected to the engine and the battery management system, wherein the automatic engine start stop system is configured to restart the engine when the at least one battery condition is not met.

6. The locomotive of claim 5 wherein the at least one battery condition is one of battery state of charge or battery state of health.

7. The power system for a locomotive of claim 5 wherein the at least one battery condition is the state of charge of the battery above a minimum threshold sufficient to restart the locomotive engine.

8. The power system for a locomotive of claim 4, wherein the battery is a first battery, further comprising:
a second battery electrically connected to the electrical system and the battery management system; and
wherein the battery management system is configured to monitor the second battery and provide power to the second auxiliary load when the engine is off and the at least one battery condition is met.

9. The power system of a locomotive of claim 8, wherein the battery management system is configured to provide power from the second battery to the second auxiliary load when the engine is off and the at least one battery condition is met.

10. The power system of a locomotive of claim 2, wherein the battery is a lithium-ion battery.

11. The power system of a locomotive of claim 1, wherein the battery management system includes a processor configured to monitor the battery temperature and pressure, the at least one antenna configured to collect the locomotive position and a GPS location, and a modem to allow data to be collected from the locomotive and transferred to an offboard facility when the engine is off.

12. A method to supply power in a locomotive, the locomotive having an engine, an alternator coupled to the engine, an electrical system that is electrically powered by the alternator, a primary load, an auxiliary load and a battery electrically connected to the electrical system, comprising:
monitoring a condition of the battery;
determining whether the condition of the battery is below a threshold value;
causing power to be provided to the auxiliary load and not the primary load from the battery when the engine is off and the condition is not below the threshold value; and
communicating with a back office to provide the condition of the battery.

13. The method of claim 12, wherein the power is provided to the auxiliary load via Power over Ethernet (PoE).

14. The method of claim 13, wherein the battery is a lithium-ion battery.

15. The method of claim 14, wherein the auxiliary load is one of a network switch, a sensor, a camera, a plurality of lights or a telematic device.

16. The method of claim 14, wherein the auxiliary load is a first auxiliary load and the locomotive further includes:
a second auxiliary load electrically connected to the electrical system, wherein the second auxiliary load is one of a heater, an air conditioner, a blower, a cooling fan or a motor driven compressor.

17. The method of claim 16, wherein the locomotive further includes an automatic engine start stop (AESS) system connected to the engine.

18. The method of claim 17, wherein the condition of the battery is the battery state of charge and the threshold value is based on the minimum state of charge of the battery required to restart the engine.

19. The method of claim 18, further including the steps of:
monitoring the temperature and pressure of the battery;
determining the locomotive position; and
sending information from the locomotive to offboard the locomotive when the engine is off.
